(19) United States
(12) Patent Application Publication
(10) Pub. No.: US 2025/0165698 A1
(43) Pub. Date: May 22, 2025

(54) CONTENT MANAGEMENT TOOL FOR CAPTURING AND GENERATIVELY TRANSFORMING CONTENT ITEM

(71) Applicant: Microsoft Technology Licensing, LLC, Redmond, WA (US)

(72) Inventors: Javier HERNANDEZ RIVERA, Somerville, MA (US); Judith AMORES FERNANDEZ, Somerville, MA (US)

(73) Assignee: Microsoft Technology Licensing, LLC, Redmond, WA (US)

(21) Appl. No.: 18/517,166

(22) Filed: Nov. 22, 2023

(51) Int. Cl. G06F 40/166

(52) U.S. Cl. CPC G06F 40/166

(57) ABSTRACT

Systems and methods for transforming a captured content item are provided. In particular, a computing device may receive a capture request to capture a content item, in response to the capture request, capture the content item and provide the content item in a first user interface element of a content management tool, apply a generative transformation function to the content item to generate a transformed content item, write the transformed content item in a second user interface element of the content management tool, receive a paste request to paste the transformed content item at a requested location, and in response to the paste request, provide the transformed content item at the requested location.

### BACKGROUND

Computing devices include a variety of productivity tools and information that facilitate the accomplishment of a variety of tasks, including copying and pasting content items between different devices and applications. For example, a clipboard tool allows users to copy and store content items (e.g., image and text) from an original location and paste the copied content items to a new location. However, it may be challenging for users to conveniently and efficiently transform (e.g., translate, correct, adapt, and/or revise) the copied content items before pasting to the new location.

It is with respect to these and other general considerations that the aspects disclosed herein have been made. Also, although relatively specific problems may be discussed, it should be understood that the examples should not be limited to solving the specific problems identified in the background or elsewhere in this disclosure.

### SUMMARY

In accordance with examples of the present disclosure, a content management tool allows users to capture and generatively transform content items and copy and paste the transformed content items to a new location. When a user captures a content item, the content management tool transforms the content item by applying a generative transformation function (e.g., translate, correct, adapt, and/or revise) to transform the content item using a generative large language model (LLM), a transformer model, a diffusion model, or a multi-modal model, other type of machine learning models, or a combination of models. For example, the generative transformation function is a natural language prompt describing one or more tasks to be performed on the content item to generate the transformed content item. The generative transformation function may be automatically selected based on a previously selected generative transformation function. Alternatively, the generative transformation function may be selected from a list of predefined generative transformation functions or defined by the user.

In accordance with at least one example of the present disclosure, a method for transforming a captured content item is provided. The method may include receiving a capture request to capture a content item, upon receiving the capture request, capturing the content item and providing the content item in a first user interface element of a content management tool, applying a generative transformation function to the content item to generate a transformed content item, writing the transformed content item in a second user interface element of the content management tool, receiving a paste request to paste the transformed content item at a requested location, and in response to receiving the paste request, providing the transformed content item at the requested location.

In accordance with at least one example of the present disclosure, a computing device for transforming a captured content item is provided. The computing device may include a processor and a memory having a plurality of instructions stored thereon that, when executed by the processor, causes the computing device to receive a capture request to capture a content item, in response to the capture request, capture the content item and provide the content item in a first user interface element of a content management tool, apply a generative transformation function to the content item to generate a transformed content item, write the transformed content item in a second user interface element of the content management tool, receive a paste request to paste the transformed content item at a requested location, and in response to the paste request, provide the transformed content item at the requested location.

In accordance with at least one example of the present disclosure, a method for transforming a captured content item is provided. The method may include receiving a capture request to capture a content item in a first application, in response to receiving the capture request, capturing the content item from the first application into a content management tool, applying a generative transformation function to the content item to generate a transformed content item, receiving a paste request to paste the transformed content item into a second application, and in response to receiving the paste request, providing the transformed content item to the second application.

This Summary is provided to introduce a selection of concepts in a simplified form, which is further described below in the Detailed Description. This Summary is not intended to identify key features or essential features of the claimed subject matter, nor is it intended to be used to limit the scope of the claimed subject matter. Additional aspects, features, and/or advantages of examples will be set forth in part in the following description and, in part, will be apparent from the description, or may be learned by practice of the disclosure.

### BRIEF DESCRIPTION OF THE DRAWINGS

Non-limiting and non-exhaustive examples are described with reference to the following Figures.

FIG. 1 depicts a block diagram of an example of an operating environment in which a content management tool may be implemented in accordance with examples of the present disclosure;

FIGS. 2A and 2B depict a flowchart of an example method of transforming a captured content item in accordance with examples of the present disclosure;

FIG. 2C depicts a flowchart of an example method of transforming a captured content item in accordance with examples of the present disclosure;

FIGS. 3A-3E depict screenshots of user interface elements of the content management tool in accordance with examples of the present disclosure;

FIGS. 4A and 4B illustrate overviews of an example generative machine learning model that may be used in accordance with examples of the present disclosure;

FIG. 5 is a block diagram illustrating example physical components of a computing device with which aspects of the disclosure may be practiced;

FIG. 6 is a simplified block diagram of a computing device with which aspects of the present disclosure may be practiced; and

FIG. 7 is a simplified block diagram of a distributed computing system in which aspects of the present disclosure may be practiced.

### DETAILED DESCRIPTION

In the following detailed description, references are made to the accompanying drawings that form a part hereof, and in which are shown by way of illustrations specific aspects or examples. These aspects may be combined, other aspects may be utilized, and structural changes may be made without departing from the present disclosure. Aspects may be practiced as methods, systems or devices. Accordingly, aspects may take the form of a hardware implementation, an entirely software implementation, or an implementation combining software and hardware aspects. The following detailed description is therefore not to be taken in a limiting sense, and the scope of the present disclosure is defined by the appended claims and their equivalents.

Computing devices include a variety of productivity tools and information that facilitate the accomplishment of a variety of tasks, including copying and pasting content items between different devices and applications. For example, a clipboard tool allows users to copy and store content items (e.g., image and text) from an original location and paste the copied content items to a new location. However, it may be challenging for users to conveniently and efficiently transform (e.g., translate, correct, adapt, and/or revise) the copied content items before pasting to the new location.

In accordance with examples of the present disclosure, a content management tool allows users to capture and generatively transform content items and copy and paste the transformed content items to a new location. For example, the content item may include texts, documents, photos, videos, and audios. When a user captures a content item, the content management tool transforms the content item by applying a generative transformation function (e.g., translate, correct, adapt, and/or revise) to transform the content item using a generative large language model (LLM), a transformer model, a diffusion model, or a multi-modal model, other type of machine learning models, or a combination of models. For example, the generative transformation function is a natural language prompt describing one or more tasks to be performed on the content item to generate the transformed content item. The content management tool further presents the transformed content item to the user to further edit and/or copy the transformed content item. In some aspects, the generative transformation function may be automatically selected based on a previously selected generative transformation function. Alternatively, the generative transformation function may be selected from a list of predefined generative transformation functions or defined by the user. It should be appreciated that the captured content item and the transformed content item may be in different modality.

In accordance with examples of the present disclosure, the content management tool provides user interface elements for interacting with users. For example, when the content item is captured, the captured content item is automatically copied into a first user interface element. The content management tool transforms the content item in the first user interface element by applying a generative transformation function defined in a second user interface element and write the transformed content item to a third user interface element. The content management tool allows users to further edit content in the user interface elements, copy the transformed content item in the third user interface element, and paste the copied content at a new location.

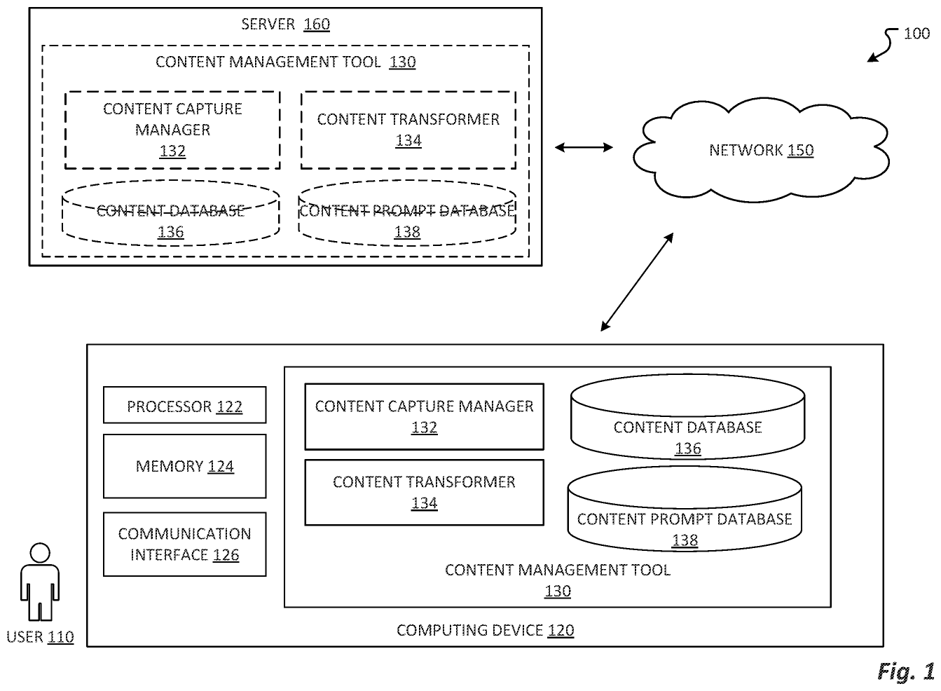

FIG. 1 depicts a block diagram of an example of an operating environment 100 in which a content management tool may be implemented in accordance with examples of the present disclosure. To do so, the operating environment 100 includes a computing device 120 associated with the user 110. The operating environment 100 may further include one or more remote devices, such as a productivity platform server 160, that are communicatively coupled to the computing device 120 via a network 150. The network 150 may include any kind of computing network including, without limitation, a wired or wireless local area network (LAN), a wired or wireless wide area network (WAN), and/or the Internet.

The computing device 120 includes a content management tool 130 executing on a computing device 120 having a processor 122, a memory 124, and a communication interface 126. The content management tool 130 allows the user 110 to copy-transform-paste content items. For example, the content management tool 130 may be a clipboard or any other productivity tool executed on the computing device 120 that has copy-and-paste and transformation functionalities. The content item may be one or more texts, documents, images, pictures, photos, videos, or audios. Additionally, the computing device 120 may be, but is not limited to, a computer, a notebook, a laptop, a mobile device, a smartphone, a tablet, a portable device, a wearable device, or any other suitable computing device that is capable of executing the content management tool 130. To do so, the content management tool 130 further includes a content capture manager 132 and a content transformer 134.

The content capture manager 132 is configured to receive a capture request to capture a content item. The capture request is any indicator that represents a user intent to capture and generatively transform the content item. The content item may be one or more texts, documents, images, pictures, photos, videos, or audios. The capture request may be a shortcut and/or a gesture assigned by an operating system or by a user. For example, a keyboard shortcut for a content capture (e.g., Ctrl+t or Window logo key+t) may be predefined by an operating system of a user's computing device and/or by a user. Additionally, or alternatively, a voice shortcut for a content capture (e.g., “transform selected content”) may be predefined by an operating system of a user's computing device and/or by a user. Additionally, or alternatively, a user may assign a gesture as a capture request. For example, a user may indicate that whenever the user takes a screenshot on the user's mobile device, the user wants the screenshot content item to be captured and transformed. When the capture request is detected, the content capture manager 132 is configured to capture the content item and write the captured content item in a user interface element (e.g., an input field) of the content management tool 130. In other words, the user may define one or more rules or action-based-rules as the capture request for capturing and copying content items into a user interface element of the content management tool 130.

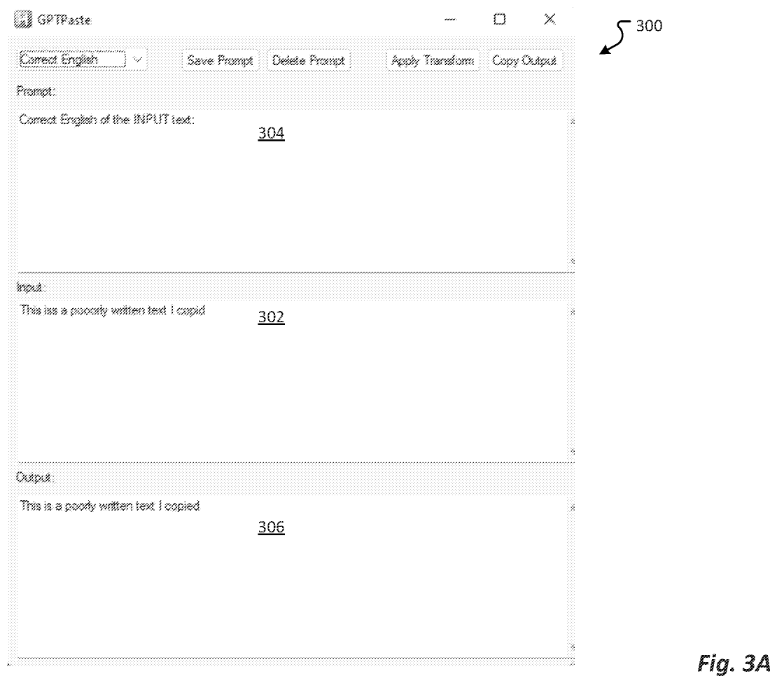

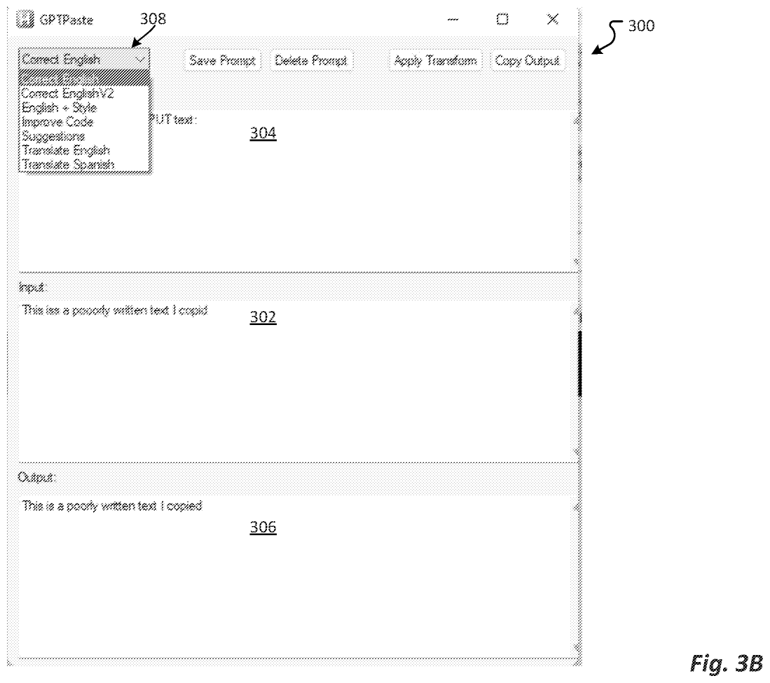

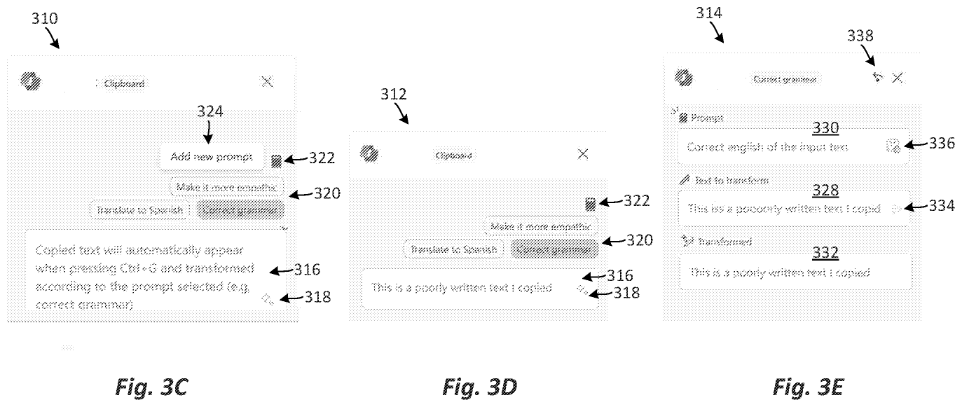

An exemplary screenshot of the content management tool 130, which includes user interface elements for interacting with users, is illustrated in FIGS. 3A and 3B. As illustrated in FIG. 3A, the captured content item is a text string “This iss a poooly written text I copid” and, in response to being captured, the captured content item is automatically copied in an input field 302 (e.g., a first user interface element) of the content management tool 130.

The content transformer 134 is configured to apply a generative transformation function to the captured content item to generate a transformed content item using a generative large language model (LLM), a transformer model, a diffusion model, or a multi-modal model, other type of machine learning models, or a combination of models. As described above, the generative transformation function is a prompt describing one or more tasks to be performed on the content item to generate the transformed content item. It should be appreciated that the generative transformation function to be applied to the content item is presented in a second user interface element (e.g., a prompt field) of the content management tool 130. For example, as illustrated in FIG. 3A, the generative transformation function to be applied to the captured content item is “Correct English of the INPUT text:” and is presented in a prompt field 304 (e.g., a second user interface element) of the content management tool 130.

According to some embodiments, the content transformer 134 is configured to automatically apply a previously selected generative transformation function to the captured content item. In some embodiments, the content transformer 134 may receive a user input identifying a generative transformation function to be applied to the captured content item. For example, the user may select a generative transformation function from a list of predefined generative transformation functions. For example, as illustrated in FIG. 3B, the user may select a generative transformation function from a drop-down menu that shows a list of predefined generative transformation functions. Alternatively, the user may define a generative transformation function in a prompt field of the content management tool 140. In some embodiments, the user may edit an existing generative transformation function presented in the prompt field of the content management tool 140.

It should be appreciated that a content prompt database 138 stores one or more predefined generative transformation functions and one or more generative transformation functions that have been previously used or defined by the user. The content transformer 134 is configured to store previously used generative transformation functions and any edits and present to the user. The user may also share one or more generative transformation functions with other users.

The content transformer 134 is further configured to write the transformed content item in a third user interface element (e.g., an output field) of the content management tool 130. For example, as illustrated in FIG. 3A, the original content item “This iss a poooly written text I copid” has been corrected to state “This is a poorly written text I copied,” which is presented in an output field 306 (e.g., a third user interface element of the content management tool 130.

Once the content item is transformed, the content capture manager 132 is further configured to determine if an edit request is received to edit the transformed content item. For example, a user may choose to further edit the transformed content item in the output field. In response to receiving the edit request, the content management tool 130 receives edit to the transformed content item in the output field of the content management tool 130.

Additionally, the content capture manager 132 is further configured to determine if a copy request is received to copy the content in the output field of the content management tool 130. It should be appreciated that the content in the output field of the content management tool 130 is the transformed content item or the edited transformed content item, if any edit has been received. In response to receiving the copy request, the content capture manager 132 is configured to store the content in the output field of the content management tool 130 as the final transformed content item in the content database 136. However, it should be appreciated that, in some embodiments, the content management tool 130 may automatically save the transformed content item in the content database 136.

It should be appreciated that the captured content item is automatically stored in the content database 136. It should be appreciated that the content database 136 is synchronized between multiple devices of the user, such that the user can capture and paste content items from any of the user's computing devices. However, it should be appreciated that, in some aspects, the content database 136 may be cloud-based content databases that is shared between the multiple devices of the user.

Depending on resources, capabilities, and capacity of the computing device used to capture the content item, the content item may be transformed from the computing device or the server 160. For example, if the user captures a content item on a user's laptop computer, the content manager tool 130 on the user's laptop computer transforms the content item by applying the selected generative transformation function using a generative large language model (LLM), a transformer model, a diffusion model, or a multi-modal model, other type of machine learning models, or a combination of models. If, however, the user captures a content item on a user's mobile device, which has less resources to perform generative transformation, the content capture manager 132 may send the captured content data to the server 160 to transform the content item. The transformed content item is then sent back to the user's mobile device to be inserted in the output field and/or stored in the content database 136.

The content capture manager 132 is further configured to determine if a paste request is received to paste the copied content at a requested location. The paste request may be a shortcut and/or a gesture assigned by an operating system or by a user. For example, a keyboard shortcut for a content capture (e.g., Ctrl+t or Window logo key+t) may be predefined by an operating system of a user's computing device and/or by a user. Additionally, or alternatively, a voice shortcut for a content capture (e.g., “transform selected content”) may be predefined by an operating system of a user's computing device and/or by a user. Additionally or alternatively, a user may assign a shortcut or gesture as a paste request. In response to receiving the paste request, the content capture manager 132 is configured to paste the content item that was most recently captured and transformed. It should be appreciated that the requested location is different from the location where the content item was originally copied from. For example, the user may copy and transform the content item from a website and paste the transformed content item to an email. In response to receiving the paste request, the content capture manager 132 is configured to write the copied content at the requested location.

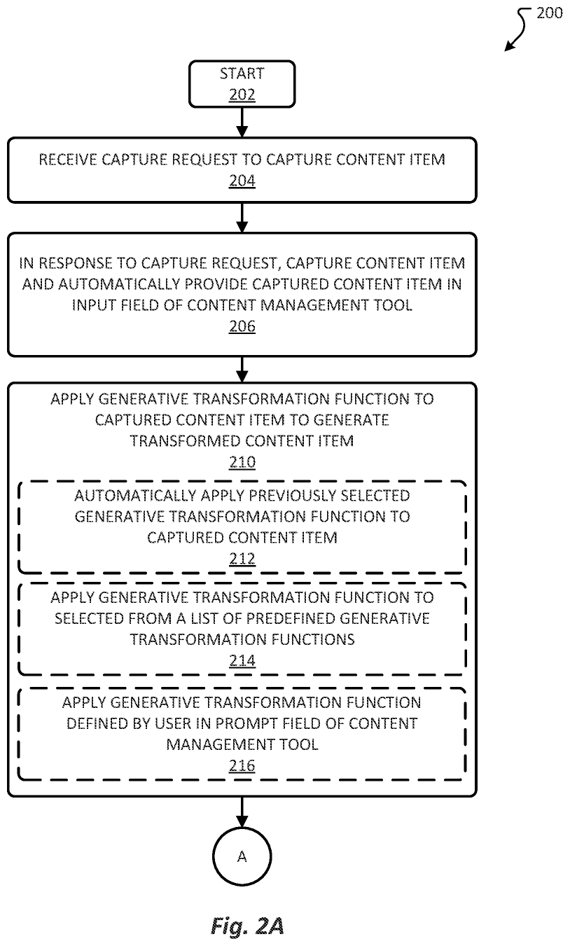

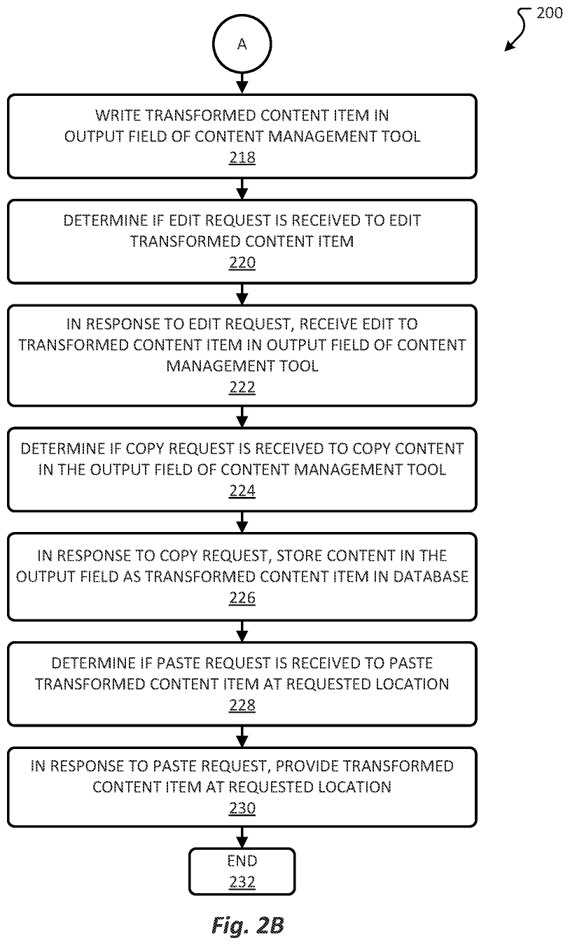

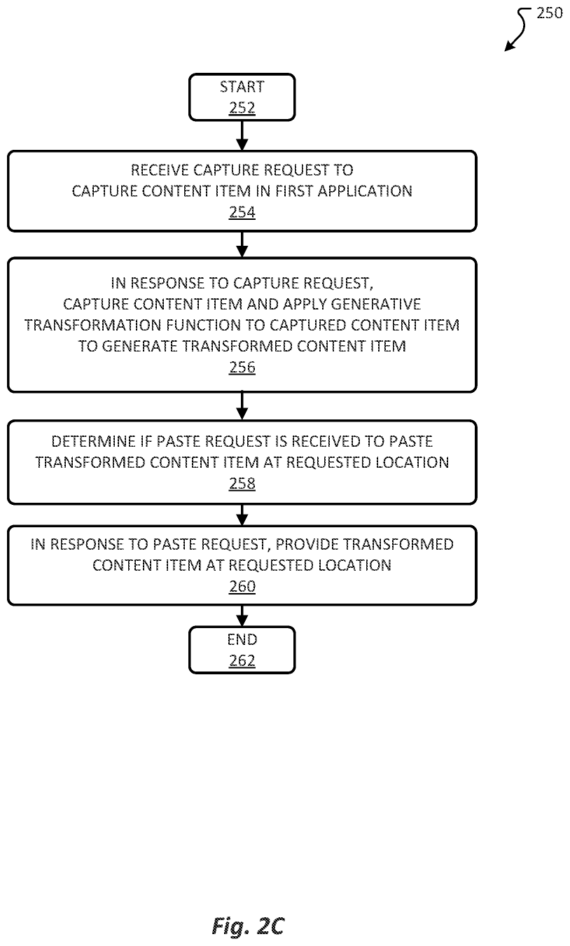

Referring now to FIGS. 2A and 2B, a method 200 for transforming copied content item in accordance with examples of the present disclosure is provided. A general order for the steps of the method 200 is shown in FIGS. 2A and 2B. Generally, the method 200 starts at 202 and ends at 232. The method 200 may include more or fewer steps or may arrange the order of the steps differently than those shown in FIGS. 2A and 2B. In the illustrative aspect, the method 200 is performed by a computing device (e.g., a user device 120) of a user 110. However, it should be appreciated that one or more steps of the method 200 may be performed by another device (e.g., a server 160).

Specifically, in some aspects, the method 200 may be performed by a content management tool (e.g., 130) executed on the user device 120. For example, the content management tool 130 is a clipboard or other productivity tool executed on the computing device 120 that has copy-and-paste and transformation functionalities. For example, the computing device 120 may be, but is not limited to, a computer, a notebook, a laptop, a mobile device, a smartphone, a tablet, a portable device, a wearable device, or any other suitable computing device that is capable of executing a content management tool (e.g., 130). For example, the server 160 may be any suitable computing device that is capable of communicating with the computing device 120. The method 200 can be executed as a set of computer-executable instructions executed by a computer system and encoded or stored on a computer readable medium. Further, the method 200 can be performed by gates or circuits associated with a processor, Application Specific Integrated Circuit (ASIC), a field programmable gate array (FPGA), a system on chip (SOC), or other hardware device. Hereinafter, the method 200 shall be explained with reference to the systems, components, modules, software, data structures, user interfaces, etc. described in conjunction with FIG. 1 and FIGS. 4-7.

The method 200 starts at operation 202, where flow may proceed to 204. At operation 204, the content management tool 130 receives a capture request to capture a content item. The capture request is any indicator that represents a user intent to capture and generatively transform the content item. The content item may be one or more texts, documents, images, pictures, photos, videos, or audios. The capture request may be a shortcut and/or a gesture assigned by an operating system or by a user. For example, a keyboard shortcut for a content capture (e.g., Ctrl+t or Window logo key+t) may be predefined by an operating system of a user's computing device and/or by a user. Additionally, or alternatively, a voice shortcut for a content capture (e.g., “transform selected content”) may be predefined by an operating system of a user's computing device and/or by a user. Additionally, or alternatively, a user may assign a gesture as a capture request. For example, a user may indicate that whenever the user takes a screenshot on the user's mobile device, the user wants the screenshot content item to be captured and transformed.

At operation 206, in response to receiving the capture request, the content management tool 130 captures the content item and automatically provides the captured content item in the input field of the content management tool 130. As described above, the content management tool 130 provides user interface elements for interacting with users. An exemplary screenshot of the content management tool 130, which includes user interface elements for interacting with users, is illustrated in FIGS. 3A and 3B. As illustrated in FIG. 3A, the captured content item is a text string “This iss a poooly written text I copid” and, in response to being captured, the captured content item is automatically copied in an input field 302 (e.g., a first user interface element) of the content management tool 130.

At operation 210, the content management tool 130 applies a generative transformation function to the captured content item to generate a transformed content item using a generative large language model (LLM), a transformer model, a diffusion model, or a multi-modal model, other type of machine learning models, or a combination of models. As described above, the generative transformation function is a prompt describing one or more tasks to be performed on the content item to generate the transformed content item. For example, the generative transformation function to be applied to the content item is provided in a prompt field (e.g., a second user interface element) of the content management tool 130. For example, as illustrated in FIG. 3A, the generative transformation function to be applied to the captured content item is “Correct English of the INPUT text:” and is presented in a prompt field 304 (e.g., a second user interface element) of the content management tool 130.

To do so, for example, the content management tool 130 may automatically apply a previously selected generative transformation function to the captured content item, as indicated in operation 212.

In some embodiments, the user may identify a generative transformation function to be applied to the captured content item. For example, the user may select a generative transformation function from a list of predefined generative transformation functions, as indicated in operation 214. For example, as illustrated in FIG. 3B, the user may select a generative transformation function from a drop-down menu 308 that shows a list of predefined generative transformation functions. In some embodiments, the drop-down menu 308 may also include a predefined number of previously selected generative transformation functions.

Alternatively, the user may define a generative transformation function in a prompt field of the content management tool 140, as indicated in operation 216. In some embodiments, the user may edit an existing generative transformation function presented in the prompt field of the content management tool 140.

According to some embodiments, the content management tool 130 may select or suggest a generative transformation function to be applied to the captured content item using a machine learning model (e.g., a generative large language model (LLM)). For example, the generative transformation function may be selected or suggested to a user based on one or more generative transformation functions previously selected for similar type of content item by the user and/or other users. Additionally, the machine learning model may further consider various parameters, including a type of application that the content item was originally copied from, types of applications that are running on the user's computing device, search histories, or any data that indicates or suggests a user intent for capturing the content item.

At operation 218, the content management tool 130 writes the transformed content item in an output field of the content management tool 130. For example, as illustrated in FIG. 3A, the original content item “This iss a poooly written text I copid” has been corrected to state “This is a poorly written text I copied,” which is presented in an output field 306 (e.g., a third user interface element of the content management tool 130. The transformed content item may be one or more texts, documents, images, pictures, photos, videos, or audios. In some embodiments, a modality of the transformed content item is different from a modality of the original content item. For example, if a user captures a text string “Cat under the Christmas Tree” (i.e., the captured content item), the content management tool 130 may generate a picture (i.e., the transformed content item) of a cat under the Christmas tree.

At operation 220, the content management tool 130 determines if an edit request is received to edit the transformed content item. For example, a user may choose to further edit the transformed content item in the output field. In response to receiving the edit request, the content management tool 130 receives edit to the transformed content item in the output field of the content management tool 130, as indicated in operation 222.

At operation 224, the content management tool 130 determines if a copy request is received to copy the content in the output field of the content management tool 130. It should be appreciated that the content in the output field of the content management tool 130 is the transformed content item or the edited transformed content item, if any edit has been received at the operations 220-222.

At operation 226, in response to receiving the copy request, the content management tool 130 stores the content in the output field of the content management tool 130 as the final transformed content item in the database. However, it should be appreciated that, in some embodiments, the content management tool 130 may automatically save the transformed content item in the database.

At operation 228, the content management tool 130 determines if a paste request is received to paste the copied content at a requested location. It should be appreciated that the requested location is different from the location where the content item was originally copied from. For example, the user may copy and transform the content item from a website and paste the transformed content item to an email application. In some embodiments, the paste request may be a shortcut and/or a gesture assigned by an operating system or by the user. For example, a keyboard shortcut for a content paste (e.g., Ctrl+g or Window logo key+g) may be predefined by an operating system of a user's computing device and/or by a user. Additionally, or alternatively, a voice shortcut for a content capture (e.g., “paste transformed content”) may be predefined by an operating system of a user's computing device and/or by a user.

At operation 230, in response to receiving the paste request, the content management tool 130 provides the copied content at the requested location. Subsequently, the method 200 may end at operation 232.

As described above, the content database is synchronized between multiple devices of the user, such that the user can capture content items from any of the user's computing devices. Depending on resources, capabilities, and capacity of the computing device used to capture the content item, the content item may be transformed from the computing device or the server 160. For example, if the user captures a content item on a user's laptop computer, the content manager tool 130 on the user's laptop computer transforms the content item by applying the selected generative transformation function using a generative transformation function (e.g., translate, correct, adapt, and/or revise) to transform the content item using a generative large language model (LLM), a transformer model, a diffusion model, or a multi-modal model, other type of machine learning models, or a combination of models. If, however, the user captures a content item on a user's mobile device, which has less resources to perform generative transformation, the content capture manager 132 may send the captured content data to the server 160 to transform the content item. The transformed content item is then sent back to the user's mobile device to be inserted in the output field and/or stored in the content database 136.

Referring now to FIG. 2C, a method 250 for transforming copied content item in accordance with examples of the present disclosure is provided. A general order for the steps of the method 250 is shown in FIG. 2C. Generally, the method 250 starts at 252 and ends at 262. The method 200 may include more or fewer steps or may arrange the order of the steps differently than those shown in FIG. 2C. In the illustrative aspect, the method 200 is performed by a computing device (e.g., a user device 120) of a user 110. However, it should be appreciated that one or more steps of the method 200 may be performed by another device (e.g., a server 160).

Specifically, in some aspects, the method 250 may be performed by a content management tool (e.g., 130) executed on the user device 120. For example, the content management tool 130 is a clipboard or other productivity tool executed on the computing device 120 that has copy-and-paste and transformation functionalities. For example, the computing device 120 may be, but is not limited to, a computer, a notebook, a laptop, a mobile device, a smartphone, a tablet, a portable device, a wearable device, or any other suitable computing device that is capable of executing a content management tool (e.g., 130). For example, the server 160 may be any suitable computing device that is capable of communicating with the computing device 120. The method 250 can be executed as a set of computer-executable instructions executed by a computer system and encoded or stored on a computer readable medium. Further, the method 200 can be performed by gates or circuits associated with a processor, Application Specific Integrated Circuit (ASIC), a field programmable gate array (FPGA), a system on chip (SOC), or other hardware device. Hereinafter, the method 250 shall be explained with reference to the systems, components, modules, software, data structures, user interfaces, etc. described in conjunction with FIG. 1 and FIGS. 4-7.

The method 250 starts at operation 252, where flow may proceed to 254. At operation 254, the content management tool 130 receives a capture request to capture a content item. The capture request is any indicator that represents a user intent to capture and generatively transform the content item. The content item may be one or more texts, documents, images, pictures, photos, videos, or audios. The capture request may be a shortcut and/or a gesture assigned by an operating system or by a user. For example, a keyboard shortcut for a content capture (e.g., Ctrl+t or Window logo key+t) may be predefined by an operating system of a user's computing device and/or by a user. Additionally, or alternatively, a voice shortcut for a content capture (e.g., “transform selected content”) may be predefined by an operating system of a user's computing device and/or by a user. Additionally, or alternatively, a user may assign a gesture as a capture request. For example, a user may indicate that whenever the user takes a screenshot on the user's mobile device, the user wants the screenshot content item to be captured and transformed.

At operation 256, in response to receiving the capture request, the content management tool 130 captures the content item and applies a generative transformation function to the captured content item to generate a transformed content item using a generative large language model (LLM), a transformer model, a diffusion model, or a multi-modal model, other type of machine learning models, or a combination of models. As described above, the generative transformation function is a prompt (e.g., a natural language prompt) describing one or more tasks to be performed on the content item to generate the transformed content item.

In some embodiments, as a default setting, a previously selected generative transformation function (e.g., a generative transformation function that was used in a preceding transformation) is automatically applied to the captured content item to generate the transformed content item. In certain embodiments, the content management tool 130 provides a user interface element (e.g., a prompt field) for receiving a user input defining a generative transformation function to be applied to the captured content item. Alternatively, the content management tool 130 provides a drop-down menu with a list of generative transformation functions for a user to select a generative transformation function from the drop-down menu. For example, the drop-down menu includes a predefined number of predefined generative transformation functions and/or previously selected generative transformation functions.

In certain embodiments, the content management tool 130 selects or suggests a generative transformation function to be applied to the captured content item using a machine learning model (e.g., a generative large language model (LLM)). For example, the generative transformation function may be selected or suggested to a user based on one or more generative transformation functions previously selected for similar type of content item by the user and/or other users. Additionally, the machine learning model may further consider various parameters, including a type of application that the content item was originally copied from, types of applications that are running on the user's computing device, search histories, or any data that indicates or suggests a user intent for capturing the content item.

At operation 258, the content management tool 130 determines if a paste request is received to paste the transformed content item at a requested location.

The paste request may be a shortcut and/or a gesture assigned by an operating system or by the user. For example, a keyboard shortcut for a content paste (e.g., Ctrl+g or Window logo key+g) may be predefined by an operating system of a user's computing device and/or by a user. Additionally, or alternatively, a voice shortcut for a content capture (e.g., “paste transformed content”) may be predefined by an operating system of a user's computing device and/or by a user. Additionally, the requested location may be different from the location where the content item was originally copied from. For example, the user may copy and transform the content item from a website and paste the transformed content item to an email application. The transformed content item may be one or more texts, documents, images, pictures, photos, videos, or audios. In some embodiments, a modality of the transformed content item is different from a modality of the original content item. For example, if a user captures a text string “Cat under the Christmas Tree” (i.e., the captured content item), the content management tool 130 may generate a picture (i.e., the transformed content item) of a cat under the Christmas tree.

At operation 260, in response to receiving the paste request, the content management tool 130 provides the transformed content item at the requested location. Subsequently, the method 250 may end at operation 262.

Referring now to FIGS. 3A and 3B, exemplary screenshots of the content management tool 130, which includes user interface elements for interacting with users, are illustrated. As illustrated in FIG. 3A, the captured content item is a text string “This iss a poooly written text I copid” and, in response to being captured, the captured content item is automatically copied in an input field 302 (e.g., a first user interface element) of the content management tool 130. Additionally, the generative transformation function to be applied to the captured content item is “Correct English of the INPUT text:” and is presented in a prompt field 304 (e.g., a second user interface element) of the content management tool 130.

In some aspects, the generative transformation function may be automatically selected based on a previously selected generative transformation function. Alternatively, the generative transformation function may be selected from a list of predefined generative transformation functions or defined by the user. For example, as illustrated in FIG. 3B, the user may select a generative transformation function from a drop-down menu that shows a list of predefined generative transformation functions. Alternatively, the user may define a generative transformation function in a prompt field 304 of the content management tool 140. In some embodiments, the user may edit an existing generative transformation function presented in the prompt field 304 of the content management tool 140.

As shown in FIG. 3A, the original content item “This iss a poooly written text I copid” has been corrected to state “This is a poorly written text I copied,” which is presented in an output field 306 (e.g., a third user interface element of the content management tool 130.

Additionally, as illustrated in FIG. 3B, the content management tool 130 includes a drop-down menu 308 that, when selected, shows a list of predefined generative transformation functions. In some embodiments, the drop-down menu 308 may also include a predefined number of previously selected generative transformation functions.

FIGS. 3C-3E illustrate exemplary screenshots of the content management tool 130 that includes user interface elements for interacting with a user similar to the user interface elements described in FIGS. 3A and 3B with different interface designs. Specifically, FIGS. 3C and 3D illustrates an interface design 310 of the content management tool 130, 312 include a new prompt icon 322, a list of generative transformation functions 320, and an output field 316, similar to the output field 306. When a user hover over on the new prompt icon 322, a popup window 324 appears next to the new prompt icon 322 with a text string: “Add new prompt”. When the new prompt icon 322 is selected, the interface design 310, 312 changes to the interface design 314, as shown in FIG. 3E.

The list of generative transformation functions 314 includes a predefined number of predefined generative transformation functions and/or one or more previously selected generative transformation functions. As described above, in the illustrative embodiment, a previous generative transformation function that was most recently selected is automatically selected. As shown in FIGS. 3C and 3D, “Correct grammar” is automatically selected and the selected generative transformation function is emphasized by highlighting the selected generative transformation function. Additionally, a user can manually select or change a desired generative transformation function from the list of generative transformation functions 320.

As shown in FIG. 3C, the interface design 310 illustrates when there is no transformed content in the output field 316. For example, it may be prior to receiving a capture request or after copying a transformed content, for example, to a clipboard. It should be appreciated that, in some embodiments, when a transformed content (e.g., text) is copied, a popup text appears indicating that “Text has been copied to the clipboard.” When there is no transformed content in the output field 316, the output field 316 provides annotation indicating a shortcut for prompting a capture request and an action to be performed upon receiving the capture request. For example, as illustrated in FIG. 3C, the annotation may state that “Copied text will automatically appear when pressing Ctrl+G and transformed according to the prompt selected (e.g., correct grammar).” It should be appreciated that, in some embodiments, the annotation may change based on the selected generative transformation function and the predefined shortcut for triggering the copy-and-transform function of the content management tool 130.

As shown in FIG. 3D, the interface design 312 illustrates when a capture request is received and the captured content is transformed and provided in the output field 316. In this example, the captured content item is a text string “This iss a poooly written text I copid” and is transformed to current grammar, as selected in the list of generative transformation functions 320. As a result, the transformed text string “This is a poorly written text I copied” is provided in the output field 316. As described above, a user can change the generative transformation function to be applied to the captured content item by selecting one from the list of generative transformation functions 320. Once the generative transformation function is selected, a transformation icon 318 is used to retransform the captured content item. For example, if a user selects “Translate to Spanish” function and selects the transformation icon 318, the content management tool 130 applies the selected generative transformation function to the captured content item and replaces the transformed text string “This is a poorly written text I copied” in the output field 318 with the new transformed content.

The user can select the new prompt icon 322 to add a new prompt. Upon selection of the new prompt icon 322, the interface design 314 of the content management tool 130 appears, as shown in FIG. 3E. The interface design 314 includes an input field 328, a prompt field 330, and an output field 332.

The prompt field 330 indicates a selected generative transformation function. However, the user may define any prompt that the user wishes to apply to the captured content item. The content management tool 130 allows the user to store the user defined prompt (e.g., generative transformation function) in the content prompt database 138 by selecting a save icon 336.

As described above, the captured content item may be automatically copied to the input field 328. Alternatively, the user may manually edit or add a content item in the input field 328. Upon selecting an icon 334, the content management tool 130 transforms the captured content in the input field 328 according to the generative transformation function defined in the prompt field 330 to generate and provide the transformed content in the output field 332.

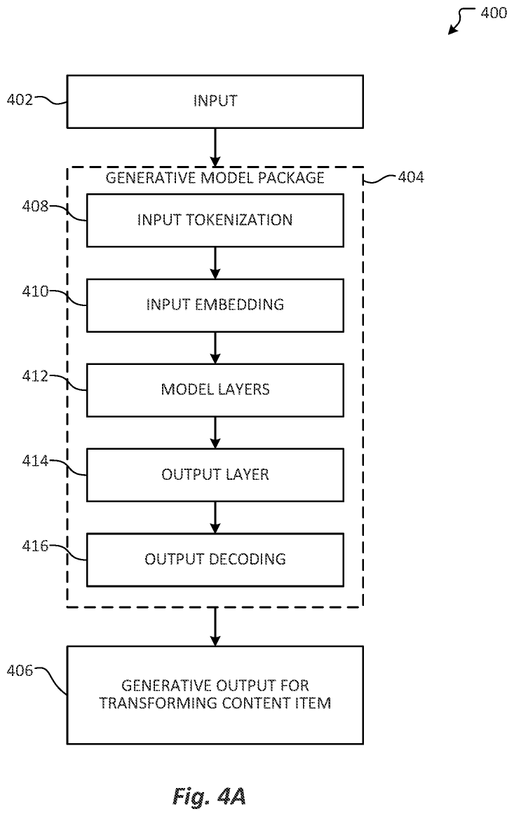

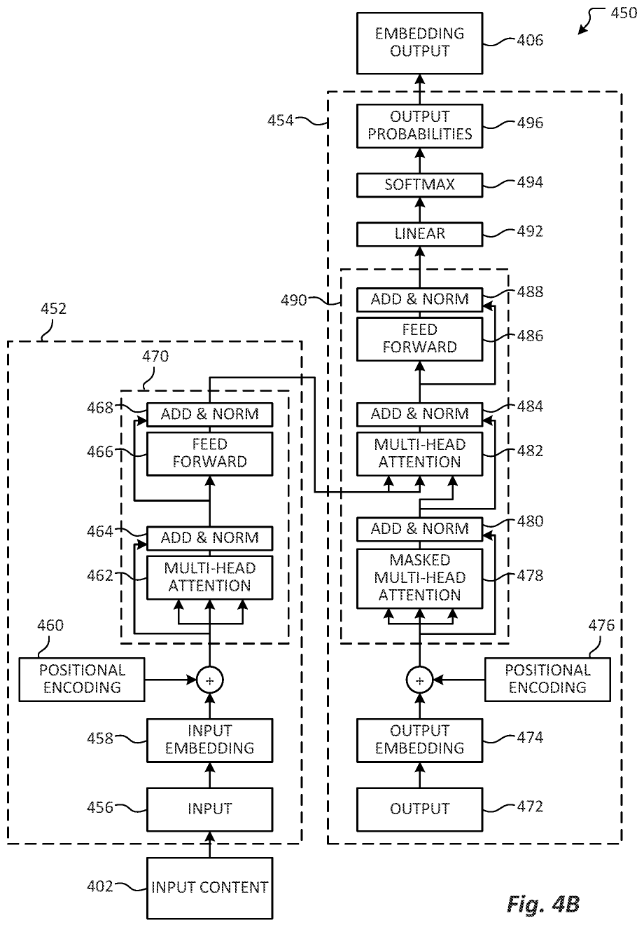

FIGS. 4A and 4B illustrate overviews of an example generative machine learning model that may be used according to aspects described herein. With reference first to FIG. 4A, conceptual diagram 400 depicts an overview of pre-trained generative model package 404 that processes an input 402 to generate model output for capturing and generatively transforming content items from a generative model output 406 (e.g., transformed content) according to aspects described herein.

In examples, generative model package 404 is pre-trained according to a variety of inputs (e.g., a variety of human languages, a variety of programming languages, and/or a variety of content types) and therefore need not be finetuned or trained for a specific scenario. Rather, generative model package 404 may be more generally pre-trained, such that input 402 includes a prompt that is generated, selected, or otherwise engineered to induce generative model package 404 to produce certain generative model output 406. It will be appreciated that input 402 and generative model output 406 may each include any of a variety of content types, including, but not limited to, text output, image output, audio output, video output, programmatic output, and/or binary output, among other examples. In examples, input 402 and generative model output 406 may have different content types, as may be the case when generative model package 404 includes a generative multimodal machine learning model.

As such, generative model package 404 may be used in any of a variety of scenarios and, further, a different generative model package may be used in place of generative model package 404 without substantially modifying other associated aspects (e.g., similar to those described herein with respect to FIGS. 1-3). Accordingly, generative model package 404 operates as a tool with which machine learning processing is performed, in which certain inputs 402 to generative model package 404 are programmatically generated or otherwise determined, thereby causing generative model package 404 to produce model output 406 that may subsequently be used for further processing.

Generative model package 404 may be provided or otherwise used according to any of a variety of paradigms. For example, generative model package 404 may be used local to a computing device (e.g., the computing device 140 in FIG. 1) or may be accessed remotely from a machine learning service (e.g., the server 160 in FIG. 1). In other examples, aspects of generative model package 404 are distributed across multiple computing devices. In some instances, generative model package 404 is accessible via an application programming interface (API), as may be provided by an operating system of the computing device and/or by the machine learning service, among other examples.

With reference now to the illustrated aspects of generative model package 404, generative model package 404 includes input tokenization 408, input embedding 410, model layers 412, output layer 414, and output decoding 416. In examples, input tokenization 408 processes input 402 to generate input embedding 410, which includes a sequence of symbol representations that corresponds to input 402. Accordingly, input embedding 410 is processed by model layers 412, output layer 414, and output decoding 416 to produce model output 406. An example architecture corresponding to generative model package 404 is depicted in FIG. 4B, which is discussed below in further detail. Even so, it will be appreciated that the architectures that are illustrated and described herein are not to be taken in a limiting sense and, in other examples, any of a variety of other architectures may be used.

FIG. 4B is a conceptual diagram that depicts an example architecture 450 of a pre-trained generative machine learning model that may be used according to aspects described herein. As noted above, any of a variety of alternative architectures and corresponding ML models may be used in other examples without departing from the aspects described herein.

As illustrated, architecture 450 processes input 402 to produce generative model output 406, aspects of which were discussed above with respect to FIG. 4A. Architecture 450 is depicted as a transformer model that includes encoder 452 and decoder 454. Encoder 452 processes input embedding 458 (aspects of which may be similar to input embedding 410 in FIG. 4A), which includes a sequence of symbol representations that corresponds to input 456. In examples, input 456 includes content data 402 corresponding to a content item.

Further, positional encoding 460 may introduce information about the relative and/or absolute position for tokens of input embedding 458. Similarly, output embedding 474 includes a sequence of symbol representations that correspond to output 472, while positional encoding 476 may similarly introduce information about the relative and/or absolute position for tokens of output embedding 474.

As illustrated, encoder 452 includes example layer 470. It will be appreciated that any number of such layers may be used, and that the depicted architecture is simplified for illustrative purposes. Example layer 470 includes two sub-layers: multi-head attention layer 462 and feed forward layer 466. In examples, a residual connection is included around each layer 462, 466, after which normalization layers 464 and 468, respectively, are included.

Decoder 454 includes example layer 490. Similar to encoder 452, any number of such layers may be used in other examples, and the depicted architecture of decoder 454 is simplified for illustrative purposes. As illustrated, example layer 490 includes three sub-layers: masked multi-head attention layer 478, multi-head attention layer 482, and feed forward layer 486. Aspects of multi-head attention layer 482 and feed forward layer 486 may be similar to those discussed above with respect to multi-head attention layer 462 and feed forward layer 466, respectively. Additionally, masked multi-head attention layer 478 performs multi-head attention over the output of encoder 452 (e.g., output 472). In examples, masked multi-head attention layer 478 prevents positions from attending to subsequent positions. Such masking, combined with offsetting the embeddings (e.g., by one position, as illustrated by multi-head attention layer 482), may ensure that a prediction for a given position depends on known output for one or more positions that are less than the given position. As illustrated, residual connections are also included around layers 478, 482, and 486, after which normalization layers 480, 484, and 488, respectively, are included.

Multi-head attention layers 462, 478, and 482 may each linearly project queries, keys, and values using a set of linear projections to a corresponding dimension. Each linear projection may be processed using an attention function (e.g., dot-product or additive attention), thereby yielding n-dimensional output values for each linear projection. The resulting values may be concatenated and once again projected, such that the values are subsequently processed as illustrated in FIG. 4B (e.g., by a corresponding normalization layer 464, 480, or 484).

Feed forward layers 466 and 486 may each be a fully connected feed-forward network, which applies to each position. In examples, feed forward layers 466 and 486 each include a plurality of linear transformations with a rectified linear unit activation in between. In examples, each linear transformation is the same across different positions, while different parameters may be used as compared to other linear transformations of the feed-forward network.

Additionally, aspects of linear transformation 492 may be similar to the linear transformations discussed above with respect to multi-head attention layers 462, 478, and 482, as well as feed forward layers 466 and 486. Softmax 494 may further convert the output of linear transformation 492 to predicted next-token probabilities, as indicated by output probabilities 496. It will be appreciated that the illustrated architecture is provided in as an example and, in other examples, any of a variety of other model architectures may be used in accordance with the disclosed aspects.

Accordingly, output probabilities 496 may thus form generative model output 406 according to aspects described herein, such that the output of the generative ML model (e.g., which may include one or more semantic embeddings and one or more content items) is used as input for determining an action according to aspects described herein. In other examples, generative model output 406 is provided as generated output for transforming a captured content item.

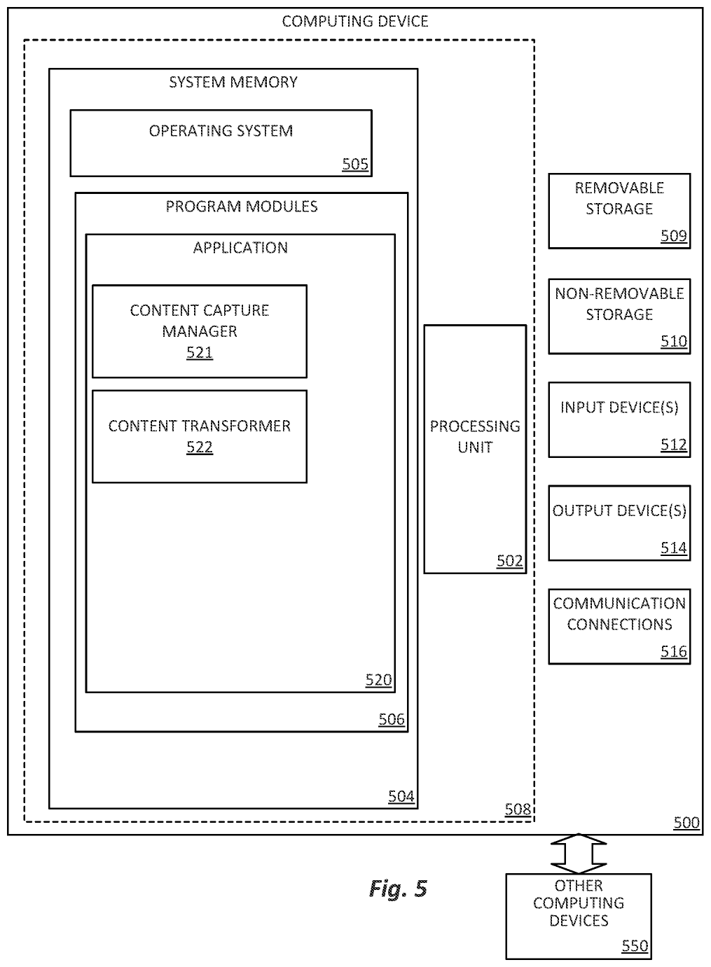

FIGS. 5-7 and the associated descriptions provide a discussion of a variety of operating environments in which aspects of the disclosure may be practiced. However, the devices and systems illustrated and discussed with respect to FIGS. 5-7 are for purposes of example and illustration and are not limiting of a vast number of computing device configurations that may be utilized for practicing aspects of the disclosure, described herein.

FIG. 5 is a block diagram illustrating physical components (e.g., hardware) of a computing device 500 with which aspects of the disclosure may be practiced. The computing device components described below may be suitable for the computing devices described above, including one or more devices associated with machine learning service (e.g., productive platform server 160), as well as computing device 140 discussed above with respect to FIG. 1. In a basic configuration, the computing device 500 may include at least one processing unit 502 and a system memory 504. Depending on the configuration and type of computing device, the system memory 504 may comprise, but is not limited to, volatile storage (e.g., random access memory), non-volatile storage (e.g., read-only memory), flash memory, or any combination of such memories.

The system memory 504 may include an operating system 505 and one or more program modules 506 suitable for running software application 520, such as one or more components supported by the systems described herein. As examples, system memory 504 may store a content capture manager 521 and/or a content transformer 522. The operating system 505, for example, may be suitable for controlling the operation of the computing device 500.

Furthermore, aspects of the disclosure may be practiced in conjunction with a graphics library, other operating systems, or any other application program and is not limited to any particular application or system. This basic configuration is illustrated in FIG. 5 by those components within a dashed line 508. The computing device 500 may have additional features or functionality. For example, the computing device 500 may also include additional data storage devices (removable and/or non-removable) such as, for example, magnetic disks, optical disks, or tape. Such additional storage is illustrated in FIG. 5 by a removable storage device 509 and a non-removable storage device 510.

As stated above, a number of program modules and data files may be stored in the system memory 504. While executing on the processing unit 502, the program modules 506 (e.g., application 520) may perform processes including, but not limited to, the aspects, as described herein. Other program modules that may be used in accordance with aspects of the present disclosure may include electronic mail and contacts applications, word processing applications, spreadsheet applications, database applications, slide presentation applications, drawing or computer-aided application programs, etc.

Furthermore, aspects of the disclosure may be practiced in an electrical circuit comprising discrete electronic elements, packaged or integrated electronic chips containing logic gates, a circuit utilizing a microprocessor, or on a single chip containing electronic elements or microprocessors. For example, aspects of the disclosure may be practiced via a system-on-a-chip (SOC) where each or many of the components illustrated in FIG. 5 may be integrated onto a single integrated circuit. Such an SOC device may include one or more processing units, graphics units, communications units, system virtualization units and various application functionality all of which are integrated (or “burned”) onto the chip substrate as a single integrated circuit. When operating via an SOC, the functionality, described herein, with respect to the capability of client to switch protocols may be operated via application-specific logic integrated with other components of the computing device 500 on the single integrated circuit (chip). Aspects of the disclosure may also be practiced using other technologies capable of performing logical operations such as, for example, AND, OR, and NOT, including but not limited to mechanical, optical, fluidic, and quantum technologies. In addition, aspects of the disclosure may be practiced within a general purpose computer or in any other circuits or systems.

The computing device 500 may also have one or more input device(s) 512 such as a keyboard, a mouse, a pen, a sound or voice input device, a touch or swipe input device, etc. The output device(s) 514 such as a display, speakers, a printer, etc. may also be included. The aforementioned devices are examples and others may be used. The computing device 500 may include one or more communication connections 516 allowing communications with other computing devices 550. Examples of suitable communication connections 516 include, but are not limited to, radio frequency (RF) transmitter, receiver, and/or transceiver circuitry; universal serial bus (USB), parallel, and/or serial ports.

The term computer readable media as used herein may include computer storage media. Computer storage media may include volatile and nonvolatile, removable and non-removable media implemented in any method or technology for storage of information, such as computer readable instructions, data structures, or program modules. The system memory 504, the removable storage device 509, and the non-removable storage device 510 are all computer storage media examples (e.g., memory storage). Computer storage media may include RAM, ROM, electrically erasable read-only memory (EEPROM), flash memory or other memory technology, CD-ROM, digital versatile disks (DVD) or other optical storage, magnetic cassettes, magnetic tape, magnetic disk storage or other magnetic storage devices, or any other article of manufacture which can be used to store information and which can be accessed by the computing device 500. Any such computer storage media may be part of the computing device 500. Computer storage media does not include a carrier wave or other propagated or modulated data signal.

Communication media may be embodied by computer readable instructions, data structures, program modules, or other data in a modulated data signal, such as a carrier wave or other transport mechanism, and includes any information delivery media. The term “modulated data signal” may describe a signal that has one or more characteristics set or changed in such a manner as to encode information in the signal. By way of example, and not limitation, communication media may include wired media such as a wired network or direct-wired connection, and wireless media such as acoustic, radio frequency (RF), infrared, and other wireless media.

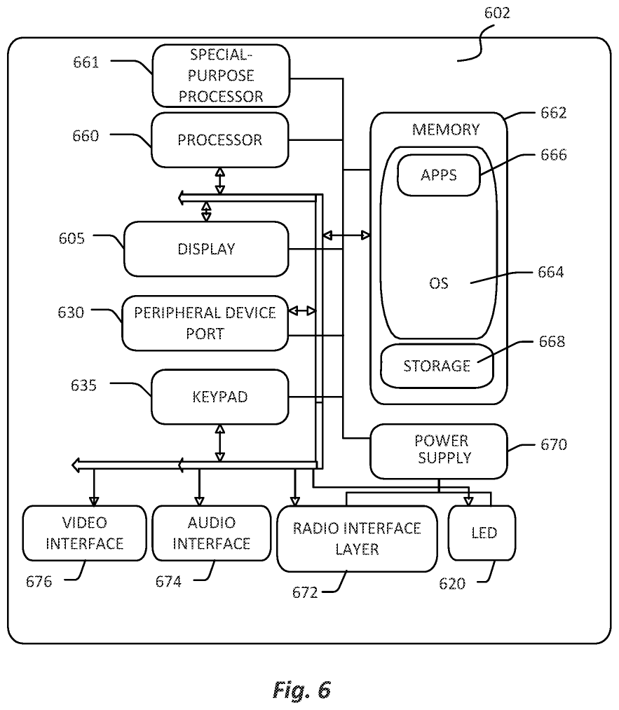

FIG. 6 illustrates a system 600 that may, for example, be a mobile computing device, such as a mobile telephone, a smart phone, wearable computer (such as a smart watch), a tablet computer, a laptop computer, and the like, with which aspects of the disclosure may be practiced. In one example, the system 600 is implemented as a “smart phone” capable of running one or more applications (e.g., browser, e-mail, calendaring, contact managers, messaging clients, games, and media clients/players). In some aspects, the system 600 is integrated as a computing device, such as an integrated personal digital assistant (PDA) and wireless phone.

In a basic configuration, such a mobile computing device is a handheld computer having both input elements and output elements. The system 600 typically includes a display 605 and one or more input buttons that allow the user to enter information into the system 600. The display 605 may also function as an input device (e.g., a touch screen display).

If included, an optional side input element allows further user input. For example, the side input element may be a rotary switch, a button, or any other type of manual input element. In alternative aspects, system 600 may incorporate more or less input elements. For example, the display 605 may not be a touch screen in some aspects. In another example, an optional keypad 635 may also be included, which may be a physical keypad or a “soft” keypad generated on the touch screen display.

In various aspects, the output elements include the display 605 for showing a graphical user interface (GUI), a visual indicator (e.g., a light emitting diode 620), and/or an audio transducer 625 (e.g., a speaker). In some aspects, a vibration transducer is included for providing the user with tactile feedback. In yet another aspect, input and/or output ports are included, such as an audio input (e.g., a microphone jack), an audio output (e.g., a headphone jack), and a video output (e.g., a HDMI port) for sending signals to or receiving signals from an external device.

One or more application programs 666 may be loaded into the memory 662 and run on or in association with the operating system 664. Examples of the application programs include phone dialer programs, e-mail programs, personal information management (PIM) programs, word processing programs, spreadsheet programs, Internet browser programs, messaging programs, and so forth. The system 600 also includes a non-volatile storage area 668 within the memory 662. The non-volatile storage area 668 may be used to store persistent information that should not be lost if the system 600 is powered down. The application programs 666 may use and store information in the non-volatile storage area 668, such as e-mail or other messages used by an e-mail application, and the like. A synchronization application (not shown) also resides on the system 600 and is programmed to interact with a corresponding synchronization application resident on a host computer to keep the information stored in the non-volatile storage area 668 synchronized with corresponding information stored at the host computer. As should be appreciated, other applications may be loaded into the memory 662 and run on the system 600 described herein (e.g., a content capture manager, a content transformer, etc.).

The system 600 has a power supply 670, which may be implemented as one or more batteries. The power supply 670 might further include an external power source, such as an AC adapter or a powered docking cradle that supplements or recharges the batteries.

The system 600 may also include a radio interface layer 672 that performs the function of transmitting and receiving radio frequency communications. The radio interface layer 672 facilitates wireless connectivity between the system 600 and the “outside world,” via a communications carrier or service provider. Transmissions to and from the radio interface layer 672 are conducted under control of the operating system 664. In other words, communications received by the radio interface layer 672 may be disseminated to the application programs 666 via the operating system 664, and vice versa.

The visual indicator 620 may be used to provide visual notifications, and/or an audio interface 674 may be used for producing audible notifications via the audio transducer 625. In the illustrated example, the visual indicator 620 is a light emitting diode (LED) and the audio transducer 625 is a speaker. These devices may be directly coupled to the power supply 670 so that when activated, they remain on for a duration dictated by the notification mechanism even though the processor 660 and other components might shut down for conserving battery power. The LED may be programmed to remain on indefinitely until the user takes action to indicate the powered-on status of the device. The audio interface 674 is used to provide audible signals to and receive audible signals from the user. For example, in addition to being coupled to the audio transducer 625, the audio interface 674 may also be coupled to a microphone to receive audible input, such as to facilitate a telephone conversation. In accordance with aspects of the present disclosure, the microphone may also serve as an audio sensor to facilitate control of notifications, as will be described below. The system 600 may further include a video interface 676 that enables an operation of an on-board camera 630 to record still images, video stream, and the like.

It will be appreciated that system 600 may have additional features or functionality. For example, system 600 may also include additional data storage devices (removable and/or non-removable) such as, magnetic disks, optical disks, or tape. Such additional storage is illustrated in FIG. 6 by the non-volatile storage area 668.

Data/information generated or captured and stored via the system 600 may be stored locally, as described above, or the data may be stored on any number of storage media that may be accessed by the device via the radio interface layer 672 or via a wired connection between the system 600 and a separate computing device associated with the system 600, for example, a server computer in a distributed computing network, such as the Internet. As should be appreciated, such data/information may be accessed via the radio interface layer 672 or via a distributed computing network. Similarly, such data/information may be readily transferred between computing devices for storage and use according to any of a variety of data/information transfer and storage means, including electronic mail and collaborative data/information sharing systems.

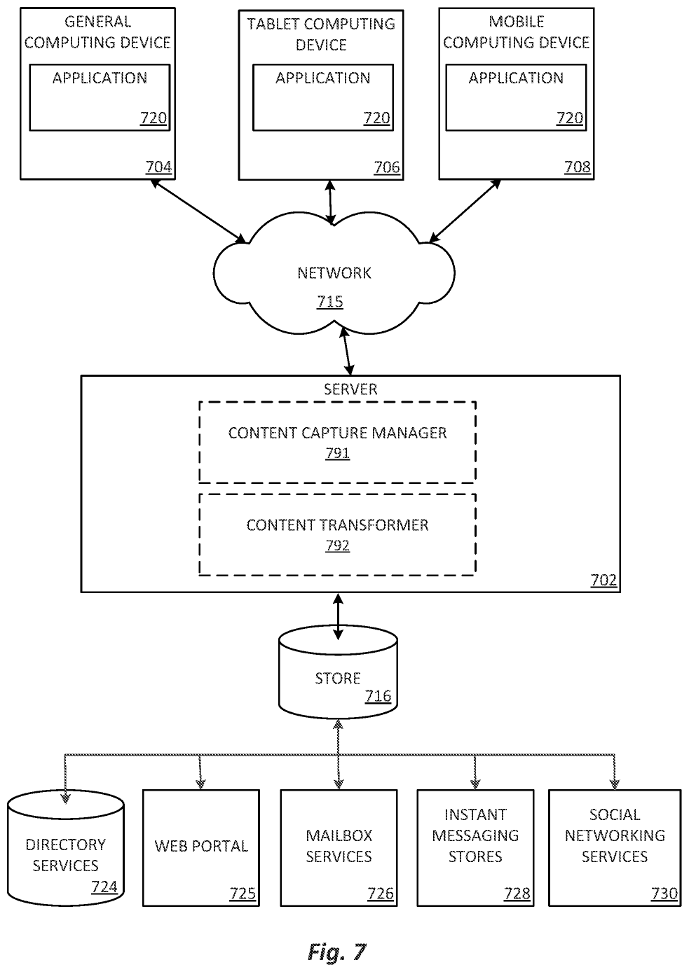

FIG. 7 illustrates one aspect of the architecture of a system for processing data received at a computing system from a remote source, such as a personal computer 704, tablet computing device 706, or mobile computing device 708, as described above. Content displayed at server device 702 may be stored in different communication channels or other storage types. For example, various documents may be stored using a directory service 724, a web portal 725, a mailbox service 726, an instant messaging store 728, or a social networking site 730.

An application 720 (e.g., similar to the application 520) may be employed by a client that communicates with server device 702. Additionally, or alternatively, a content capture manager 791 and/or a content transformer 792 may be employed by server device 702. The server device 702 may provide data to and from a client computing device such as a personal computer 704, a tablet computing device 706 and/or a mobile computing device 708 (e.g., a smart phone) through a network 715. By way of example, the computer system described above may be embodied in a personal computer 704, a tablet computing device 706 and/or a mobile computing device 708 (e.g., a smart phone). Any of these examples of the computing devices may obtain content from the store 716, in addition to receiving graphical data useable to be either pre-processed at a graphic-originating system, or post-processed at a receiving computing system.

It will be appreciated that the aspects and functionalities described herein may operate over distributed systems (e.g., cloud-based computing systems), where application functionality, memory, data storage and retrieval and various processing functions may be operated remotely from each other over a distributed computing network, such as the Internet or an intranet. User interfaces and information of various types may be displayed via on-board computing device displays or via remote display units associated with one or more computing devices. For example, user interfaces and information of various types may be displayed and interacted with on a wall surface onto which user interfaces and information of various types are projected. Interaction with the multitude of computing systems with which aspects of the disclosure may be practiced include, keystroke entry, touch screen entry, voice or other audio entry, gesture entry where an associated computing device is equipped with detection (e.g., camera) functionality for capturing and interpreting user gestures for controlling the functionality of the computing device, and the like.

Aspects of the present disclosure, for example, are described above with reference to block diagrams and/or operational illustrations of methods, systems, and computer program products according to aspects of the disclosure. The functions/acts noted in the blocks may occur out of the order as shown in any flowchart. For example, two blocks shown in succession may in fact be executed substantially concurrently or the blocks may sometimes be executed in the reverse order, depending upon the functionality/acts involved.

The description and illustration of one or more aspects provided in this application are not intended to limit or restrict the scope of the disclosure as claimed in any way. The aspects, examples, and details provided in this application are considered sufficient to convey possession and enable others to make and use claimed aspects of the disclosure. The claimed disclosure should not be construed as being limited to any aspect, example, or detail provided in this application. Regardless of whether shown and described in combination or separately, the various features (both structural and methodological) are intended to be selectively included or omitted to produce an aspect with a particular set of features. Having been provided with the description and illustration of the present application, one skilled in the art may envision variations, modifications, and alternate aspects falling within the spirit of the broader aspects of the general inventive concept embodied in this application that do not depart from the broader scope of the claimed disclosure.

In addition, the aspects and functionalities described herein may operate over distributed systems (e.g., cloud-based computing systems), where application functionality, memory, data storage and retrieval and various processing functions may be operated remotely from each other over a distributed computing network, such as the Internet or an intranet. User interfaces and information of various types may be displayed via on-board computing device displays or via remote display units associated with one or more computing devices. For example, user interfaces and information of various types may be displayed and interacted with on a wall surface onto which user interfaces and information of various types are projected. Interaction with the multitude of computing systems with which aspects of the disclosure may be practiced include, keystroke entry, touch screen entry, voice or other audio entry, gesture entry where an associated computing device is equipped with detection (e.g., camera) functionality for capturing and interpreting user gestures for controlling the functionality of the computing device, and the like.

The phrases “at least one,” “one or more,” “or,” and “and/or” are open-ended expressions that are both conjunctive and disjunctive in operation. For example, each of the expressions “at least one of A, B and C,” “at least one of A, B, or C,” “one or more of A, B, and C,” “one or more of A, B, or C,” “A, B, and/or C,” and “A, B, or C” means A alone, B alone, C alone, A and B together, A and C together, B and C together, or A, B and C together.

The term “a” or “an” entity refers to one or more of that entity. As such, the terms “a” (or “an”), “one or more,” and “at least one” can be used interchangeably herein. It is also to be noted that the terms “comprising,” “including,” and “having” can be used interchangeably.

The term “automatic” and variations thereof, as used herein, refers to any process or operation, which is typically continuous or semi-continuous, done without material human input when the process or operation is performed. However, a process or operation can be automatic, even though performance of the process or operation uses material or immaterial human input, if the input is received before performance of the process or operation. Human input is deemed to be material if such input influences how the process or operation will be performed. Human input that consents to the performance of the process or operation is not deemed to be “material.”

Any of the steps, functions, and operations discussed herein can be performed continuously and automatically.

The example systems and methods of this disclosure have been described in relation to computing devices. However, to avoid unnecessarily obscuring the present disclosure, the preceding description omits several known structures and devices. This omission is not to be construed as a limitation. Specific details are set forth to provide an understanding of the present disclosure. It should, however, be appreciated that the present disclosure may be practiced in a variety of ways beyond the specific detail set forth herein.

Furthermore, while the example aspects illustrated herein show the various components of the system collocated, certain components of the system can be located remotely, at distant portions of a distributed network, such as a LAN and/or the Internet, or within a dedicated system. Thus, it should be appreciated, that the components of the system can be combined into one or more devices, such as a server, communication device, or collocated on a particular node of a distributed network, such as an analog and/or digital telecommunications network, a packet-switched network, or a circuit-switched network. It will be appreciated from the preceding description, and for reasons of computational efficiency, that the components of the system can be arranged at any location within a distributed network of components without affecting the operation of the system.

Furthermore, it should be appreciated that the various links connecting the elements can be wired or wireless links, or any combination thereof, or any other known or later developed element(s) that is capable of supplying and/or communicating data to and from the connected elements. These wired or wireless links can also be secure links and may be capable of communicating encrypted information. Transmission media used as links, for example, can be any suitable carrier for electrical signals, including coaxial cables, copper wire, and fiber optics, and may take the form of acoustic or light waves, such as those generated during radio-wave and infra-red data communications.

While the flowcharts have been discussed and illustrated in relation to a particular sequence of events, it should be appreciated that changes, additions, and omissions to this sequence can occur without materially affecting the operation of the disclosed configurations and aspects.

Several variations and modifications of the disclosure can be used. It would be possible to provide for some features of the disclosure without providing others.

In yet another configurations, the systems and methods of this disclosure can be implemented in conjunction with a special purpose computer, a programmed microprocessor or microcontroller and peripheral integrated circuit element(s), an ASIC or other integrated circuit, a digital signal processor, a hard-wired electronic or logic circuit such as discrete element circuit, a programmable logic device or gate array such as PLD, PLA, FPGA, PAL, special purpose computer, any comparable means, or the like. In general, any device(s) or means capable of implementing the methodology illustrated herein can be used to implement the various aspects of this disclosure. Example hardware that can be used for the present disclosure includes computers, handheld devices, telephones (e.g., cellular, Internet enabled, digital, analog, hybrids, and others), and other hardware known in the art. Some of these devices include processors (e.g., a single or multiple microprocessors), memory, nonvolatile storage, input devices, and output devices. Furthermore, alternative software implementations including, but not limited to, distributed processing or component/object distributed processing, parallel processing, or virtual machine processing can also be constructed to implement the methods described herein.

In yet another configuration, the disclosed methods may be readily implemented in conjunction with software using object or object-oriented software development environments that provide portable source code that can be used on a variety of computer or workstation platforms. Alternatively, the disclosed system may be implemented partially or fully in hardware using standard logic circuits or VLSI design. Whether software or hardware is used to implement the systems in accordance with this disclosure is dependent on the speed and/or efficiency requirements of the system, the particular function, and the particular software or hardware systems or microprocessor or microcomputer systems being utilized.

In yet another configuration, the disclosed methods may be partially implemented in software that can be stored on a storage medium, executed on programmed general-purpose computer with the cooperation of a controller and memory, a special purpose computer, a microprocessor, or the like. In these instances, the systems and methods of this disclosure can be implemented as a program embedded on a personal computer such as an applet, JAVA® or CGI script, as a resource residing on a server or computer workstation, as a routine embedded in a dedicated measurement system, system component, or the like. The system can also be implemented by physically incorporating the system and/or method into a software and/or hardware system.

The disclosure is not limited to standards and protocols if described. Other similar standards and protocols not mentioned herein are in existence and are included in the present disclosure. Moreover, the standards and protocols mentioned herein, and other similar standards and protocols not mentioned herein are periodically superseded by faster or more effective equivalents having essentially the same functions. Such replacement standards and protocols having the same functions are considered equivalents included in the present disclosure.

In accordance with at least one example of the present disclosure, a method for transforming a captured content item is provided. The method may include receiving a capture request to capture a content item, upon receiving the capture request, capturing the content item and providing the content item in a first user interface element of a content management tool, applying a generative transformation function to the content item to generate a transformed content item, writing the transformed content item in a second user interface element of the content management tool, receiving a paste request to paste the transformed content item at a requested location, and in response to receiving the paste request, providing the transformed content item at the requested location.

In accordance with at least one aspect of the above method, the method may include where receiving the capture request to capture the content item comprises receiving a capture request to capture a content item in a first application, and where the requested location is in a second application that is different from the first application.

In accordance with at least one aspect of the above method, the method may include where applying the generative transformation function to the content item comprises automatically applying a previously selected generative transformation function to the content item.

In accordance with at least one aspect of the above method, the method may include where applying the generative transformation function to the content item comprises receiving a user input indicating the generative transformation function to be applied to the content item.

In accordance with at least one aspect of the above method, the method may include where the user input is an indication of the generative transformation function in a third user interface element of the content management tool.

In accordance with at least one aspect of the above method, the method may include where the user input is a selection of the generative transformation function from a list of predefined generative transformation functions.

In accordance with at least one aspect of the above method, the method may include where the generative transformation function is a natural language prompt describing one or more tasks to be performed on the content item to generate the transformed content item.

In accordance with at least one aspect of the above method, the method may further include prior to receiving a copy request, receiving an edit request to edit the transformed content item.

In accordance with at least one aspect of the above method, the method may further include receiving a copy request to copy the transformed content item, and in response to receiving the copy request, storing the transformed content item to a database.

In accordance with at least one aspect of the above method, the method may include where applying the generative transformation function to the content item to generate the transformed content item comprises applying the generative transformation function to the content item using at least one of: a generative large language model (LLM), a transformer model, a diffusion model, or a multi-modal model.

In accordance with at least one aspect of the above method, the method may include where the content item is at least one of text, image, or audio, and the transformed content item is at least one of text, image, or audio.

In accordance with at least one example of the present disclosure, a computing device for transforming a captured content item is provided. The computing device may include a processor and a memory having a plurality of instructions stored thereon that, when executed by the processor, causes the computing device to receive a capture request to capture a content item, in response to the capture request, capture the content item and provide the content item in a first user interface element of a content management tool, apply a generative transformation function to the content item to generate a transformed content item, write the transformed content item in a second user interface element of the content management tool, receive a paste request to paste the transformed content item at a requested location, and in response to the paste request, provide the transformed content item at the requested location.

In accordance with at least one aspect of the above computing device, the computing device may include where to receive the capture request to capture the content item comprises to receive a capture request to capture a content item in a first application, and wherein the requested location is in a second application that is different from the first application.

In accordance with at least one aspect of the above computing device, the computing device may include where to apply the generative transformation function to the content item comprises to automatically apply a previously selected generative transformation function to the content item.

In accordance with at least one aspect of the above computing device, the computing device may include where to apply the generative transformation function to the content item comprises to receive a user input indicating the generative transformation function to be applied to the content item.

In accordance with at least one aspect of the above computing device, the computing device may include where the user input is an indication of the generative transformation function in a third user interface element of the content management tool, or a selection of the generative transformation function from a list of predefined generative transformation functions.

In accordance with at least one aspect of the above computing device, the computing device may include where the generative transformation function is a natural language prompt describing one or more tasks to be performed on the content item to generate the transformed content item.

In accordance with at least one example of the present disclosure, a method for transforming a captured content item is provided. The method may include receiving a capture request to capture a content item in a first application, in response to receiving the capture request, capturing the content item from the first application into a content management tool, applying a generative transformation function to the content item to generate a transformed content item, receiving a paste request to paste the transformed content item into a second application, and in response to receiving the paste request, providing the transformed content item to the second application.

In accordance with at least one aspect of the above method, the method may include where the generative transformation function is a natural language prompt describing one or more tasks to be performed on the content item to generate the transformed content item.

In accordance with at least one aspect of the above method, the method may include where applying the generative transformation function to the content item comprises to: automatically applying a previously selected generative transformation function to the content item, or receiving a user input indicating the generative transformation function to be applied to the content item.

The present disclosure, in various configurations and aspects, includes components, methods, processes, systems and/or apparatus substantially as depicted and described herein, including various combinations, subcombinations, and subsets thereof. Those of skill in the art will understand how to make and use the systems and methods disclosed herein after understanding the present disclosure. The present disclosure, in various configurations and aspects, includes providing devices and processes in the absence of items not depicted and/or described herein or in various configurations or aspects hereof, including in the absence of such items as may have been used in previous devices or processes, e.g., for improving performance, achieving ease, and/or reducing cost of implementation.

What is claimed is:

1. A method for transforming a captured content item, the method comprising:
receiving a capture request to capture a content item;
upon receiving the capture request, capturing the content item and providing the content item in a first user interface element of a content management tool;
applying a generative transformation function to the content item to generate a transformed content item;
writing the transformed content item in a second user interface element of the content management tool;
receiving a paste request to paste the transformed content item at a requested location; and
in response to receiving the paste request, providing the transformed content item at the requested location.

2. The method of claim 1,
wherein receiving the capture request to capture the content item comprises receiving a capture request to capture a content item in a first application, and
wherein the requested location is in a second application that is different from the first application.

3. The method of claim 1, wherein applying the generative transformation function to the content item comprises:
automatically applying a previously selected generative transformation function to the content item.

4. The method of claim 1, wherein applying the generative transformation function to the content item comprises:
receiving a user input indicating the generative transformation function to be applied to the content item.

5. The method of claim 4, wherein the user input is an indication of the generative transformation function in a third user interface element of the content management tool.

6. The method of claim 4, wherein the user input is a selection of the generative transformation function from a list of predefined generative transformation functions.

7. The method of claim 1, wherein the generative transformation function is a natural language prompt describing one or more tasks to be performed on the content item to generate the transformed content item.

8. The method of claim 1, further comprising:
prior to receiving a copy request, receiving an edit request to edit the transformed content item.

9. The method of claim 1, further comprising:
receiving a copy request to copy the transformed content item; and
in response to receiving the copy request, storing the transformed content item to a database.

10. The method of claim 1, wherein applying the generative transformation function to the content item to generate the transformed content item comprises applying the generative transformation function to the content item using at least one of: a generative large language model (LLM), a transformer model, a diffusion model, or a multi-modal model.

11. The method of claim 1, wherein the content item is at least one of text, image, or audio, and the transformed content item is at least one of text, image, or audio.

12. A computing device for transforming a captured content item, the computing device comprising:
a processor; and
a memory having a plurality of instructions stored thereon that, when executed by the processor, causes the computing device to:
receive a capture request to capture a content item;
in response to the capture request, capture the content item and provide the content item in a first user interface element of a content management tool;
apply a generative transformation function to the content item to generate a transformed content item;
write the transformed content item in a second user interface element of the content management tool;
receive a paste request to paste the transformed content item at a requested location; and
in response to the paste request, provide the transformed content item at the requested location.

13. The computing device of claim 11, wherein to receive the capture request to capture the content item comprises to receive a capture request to capture a content item in a first application, and wherein the requested location is in a second application that is different from the first application.

14. The computing device of claim 11, wherein to apply the generative transformation function to the content item comprises to automatically apply a previously selected generative transformation function to the content item.

15. The computing device of claim 11, wherein to apply the generative transformation function to the content item comprises to receive a user input indicating the generative transformation function to be applied to the content item.

16. The computing device of claim 14, wherein the user input is an indication of the generative transformation function in a third user interface element of the content management tool, or a selection of the generative transformation function from a list of predefined generative transformation functions.

17. The computing device of claim 11, wherein the generative transformation function is a natural language prompt describing one or more tasks to be performed on the content item to generate the transformed content item.

18. A method for transforming a captured content item, the method comprising:
receiving a capture request to capture a content item in a first application;
in response to receiving the capture request, capturing the content item from the first application into a content management tool;
applying a generative transformation function to the content item to generate a transformed content item;
receiving a paste request to paste the transformed content item into a second application; and
in response to receiving the paste request, providing the transformed content item to the second application.

19. The method of claim 18, wherein the generative transformation function is a natural language prompt describing one or more tasks to be performed on the content item to generate the transformed content item.

20. The method of claim 18, wherein applying the generative transformation function to the content item comprises to:
automatically applying a previously selected generative transformation function to the content item; or
receiving a user input indicating the generative transformation function to be applied to the content item.
